(19) United States
(12) Patent Application Publication
(10) Pub. No.: US 2007/0190973 A1
(43) Pub. Date: Aug. 16, 2007

(54) Base station, wireless communication systems, base station control programs and base station control methods

(75) Inventors: Masataka Goto, Yokohama-Shi (JP); Yoshimichi Tanizawa, Yokohama-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/438,374

(22) Filed: May 23, 2006

(30) Foreign Application Priority Data
May 23, 2005 (JP) 2005-149862

(51) Int. Cl. H04M 3/16

(52) U.S. Cl. 455/410

(57) ABSTRACT

A base station has a wireless unit configured to perform wireless communication with a wireless terminal by using a predetermined protocol, and a control unit configured to select one of a plurality of security parameter sets relating to authentication schemes and encryption schemes used for the wireless communication with the wireless terminal at a predetermined timing to provide the selected security parameter set to the wireless terminal via the wireless unit.

### CROSS REFERENCE TO RELATED APPLICATIONS

This application is based upon and claims the benefit of priority from the prior Japanese Patent Application No. 2005-149862, filed on May 23, 2005, the entire contents of which are incorporated herein by reference.

### BACKGROUND OF THE INVENTION

1. Field of the Invention

The present invention relates to a base station, a wireless communication system, a base station control program and a base station control method which perform wireless communication with a wireless terminal.

2. Related Art

There has been deep-rooted concern of security due to wireless communication in terms of wireless LAN standardized by the IEEE802.11 committee. The committee is continuing standardization work for authentication and encryption such as WEP (Wired Equivalent Privacy), WPA (Wi-Fi Protected Access), IEEE802.11i Wireless LAN MAC Security Enhancements (see, for example, “IEEE Standard for Information technology Telecommunications and information exchange between systems Local and metropolitan area networks Specific requirements Part 11: Wireless LAN Medium Access Control (MAC) and Physical Layer (PHY) specifications Amendment 6: Medium Access Control (MAC) Security Enhancements”).

In terms of connection over wireless LAN with security, the connection cannot be established if settings of security parameters do not match in both of an access point and a client terminal. As a way to simplify security parameter setting, it is assumable to initially establish a connection without security or with a pre-determined fixed security setting, to perform authentication procedure and exchange of the security parameters, and then to set arbitrary security parameters to establish a full connection.

However, if an access point with security and an access point without security are provided to realize the above system, there may be problems in installation cost, management cost and electromagnetic interference.

In order to permit a setting change with/without security to each access point, it is necessary to handle a plurality of SSIDs. In this case, the client terminal has to perform the same processing procedure as that of the case where two different access points are arranged. Therefore, the security setting is complicated.

In order to avoid the above described problem, it is assumed that the setting change of the security is manually indicated due to a method of pushing a button. When the number of the arranged access points, management of the access points and the number of the connected terminals increase, the number of buttons also increase. Therefore, the processings are complicated, and operational errors also increase.

### SUMMARY OF THE INVENTION

The present invention provides a base station, a wireless communication system, a base station control program and a base station control method which perform wireless communication with a wireless terminal safely and securely, with simplified procedures and without suffering security performance.

According to one embodiment of the present invention, a base station comprising:

a wireless unit configured to perform wireless communication with a wireless terminal by using a predetermined protocol, authentication schemes, and encryption schemes; and

a control unit configured to select one of a plurality of security parameter sets relating to the authentication schemes and encryption schemes at a predetermined timing to provide the selected security parameter set to the wireless terminal via the wireless unit.

According to one embodiment of the present invention, a wireless communication system comprising:

a wireless terminal; and

a base station configured to perform wireless communication with the wireless terminal, the base station includes:

a wireless unit configured to perform wireless communication with a wireless terminal by using a predetermined protocol, authentication schemes, and encryption schemes; and

a control unit configured to select one of a plurality of security parameter sets relating to the authentication schemes and encryption schemes at a predetermined timing to provide the selected security parameter set to the wireless terminal via the wireless unit.

According to one embodiment of the present invention, a base station control program comprising:

selecting one of a plurality of security parameter sets relating to authentication schemes and encryption schemes used for wireless communication with a wireless terminal at a predetermined timing; and

transmitting information relating to the authentication scheme and encryption scheme of the selected security parameter set to the wireless terminal.

According to one embodiment of the present invention, a base station control method comprising:

selecting one of a plurality of security parameter sets relating to authentication schemes and encryption schemes used for wireless communication with a wireless terminal at a predetermined timing; and

transmitting information relating to the authentication scheme and encryption scheme of the selected security parameter set to the wireless terminal.

### BRIEF DESCRIPTION OF THE DRAWINGS

FIG. 1 is a block diagram schematically illustrating the configuration of a wireless communication system according to one embodiment of the present invention;

FIG. 2 is a block diagram illustrating an example of the internal configuration of an access point 2 in FIG. 1;

FIG. 3 is a diagram showing an example of parameter information held by an AP MAC control unit 16;

FIG. 4 is a diagram showing the types of parameters included in a security parameter set and values that can be taken by the parameters;

FIG. 5 is a diagram showing frame configuration of a beacon in the IEEE802.11 series standard;

FIG. 6 is a diagram showing correspondence among authentication schemes, encryption schemes, and the descriptions of the “Privacy” field 24 and the RSN-IE 23 within the beacon frame;

FIG. 7 is a diagram showing an example of description of the AKM Suite List field 28 within the RSN-IE 23 in first connection processing;

FIG. 8 is a diagram showing an example of description of the Pairwise Cipher Suite List field 26 within the RSN-IE 23 in the first connection processing;

FIG. 9 is a sequence diagram illustrating the detailed processing procedure of the first connection processing;

FIG. 10 is a diagram showing an example of a control table of security parameters held by an AP MAC control unit;

FIG. 11 is a diagram showing an example of a control table of a security parameter held by a wireless terminal;

FIG. 12 is a diagram showing an example of a control table of a security parameter held by an AP MAC control unit 16 within an access point 2;

FIG. 13 is a diagram showing timings at which an access point 2 switches security parameter sets;

FIG. 14 is a diagram showing an example of a control table of a security parameter within which information 32 about the duration of each security parameter set has been added;

FIG. 15 is a diagram showing the switching timings of the security parameter sets corresponding to FIG. 14;

FIG. 16 is a timing diagram illustrating an example in which security parameter sets change in sync with a trigger signal;

FIG. 17 is a timing diagram illustrating a case in which information about the next security parameter set to be selected is contained in a trigger signal;

FIG. 18 is a sequence diagram illustrating the detailed processing procedure of second connection processing;

FIG. 19 shows a control table of a security parameter held by an AP MAC control unit;

FIG. 20 is a diagram showing parameter information initially set for a wireless terminal 1; and

FIG. 21 is a diagram showing parameter information later set for the wireless terminal 1.

### DETAILED DESCRIPTION OF THE INVENTION

One embodiment of the present invention will now be described below with reference to the drawings.

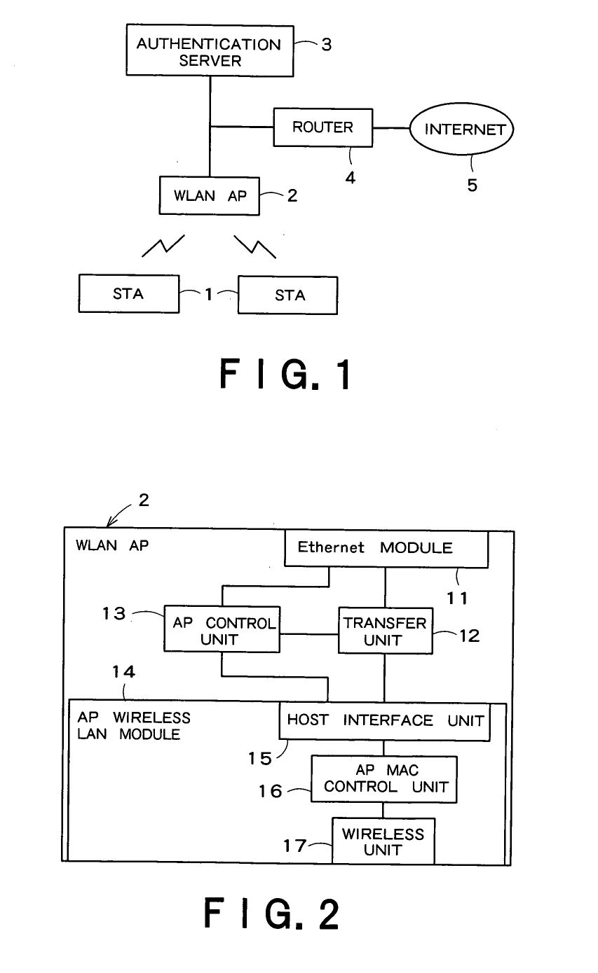

FIG. 1 is a block diagram showing schematic configuration of a wireless communication system according to one embodiment of the present invention. The wireless communication system shown in FIG. 1 includes an access point 2 for wireless LAN (WLAN AP) which performs wireless communications with a plurality of wireless terminals 1 (STA), an authentication server 3 connected via a wired Ethernet (registered trademark) or the like to the access point 2, and a router 4 connected to the access point 2 and the authentication server 3. The access point 2 and the authentication server 3 are placed in an environment capable of being connected via the router 4 to the Internet 5.

The authentication server 3 is a server for authenticating the wireless terminals 1 on the wireless LAN. Various protocols such as IEEE802.1X, IEEE802.11i, WPA and PANA. may be used for the authentication procedure, and the protocol is not limited to any particular type of protocol in the present embodiment.

Although in FIG. 1 the access point 2 and the authentication server 3 are directly connected (on link), they may also be connected via the router 4 shown in FIG. 1 or another router 4. The authentication server 3 is not necessarily an inevitable component since there may be a case where the authentication server 3 is not needed depending on the authentication scheme employed.

The wireless terminals 1 may or may not be equipped with functions according to the security standards of wireless LAN such as IEEE802.11, IEEE802.11i and WPA, or both types of terminals may be mixed in a system.

FIG. 2 is a block diagram illustrating an example of the internal configuration of the access point 2 in FIG. 1. The access point 2 in FIG. 2 has an Ethernet module 11, a transfer unit 12, an AP control unit 13, and an AP wireless LAN module 14. The Ethernet module 11 is a module for performing communication via wired Ethernet connections. The transfer unit 12 plays a role of transferring communications from the wireless LAN segment to the wired Ethernet segment, and vice versa. The AP control unit 13 controls the settings of the Ethernet module 11, the transfer unit 12 and the AP wireless LAN module 14, and controls the overall operation of the access point 2.

Inside the AP wireless LAN module 14, a host interface unit 15, an AP MAC control unit 16, and a wireless unit 17 are provided. The host interface unit 15 relays transmission relating to the settings with the AP control unit 13 and data communication with the transfer unit 12. The AP MAC control unit 16 controls the wireless unit 17 so that it operates according to the specifications of IEEE802.11. The wireless unit 17 performs the functions of the physical layer including antennas.

The access point 2 may have a plurality of the Ethernet modules 11, a plurality of the transfer units 12 and a plurality of the AP wireless LAN modules 14, respectively, and such an access point 2 is also assumed to be included within the present embodiment.

A more detailed description of the AP wireless LAN module 14, which characterizes the present embodiment, will be presented below.

The AP MAC control unit 16 holds parameter information for wireless LAN transmitted via the host interface unit 15 from the AP control unit 13 and uses this parameter information to control the wireless unit 17 to perform communications according to the IEEE802.11 standards.

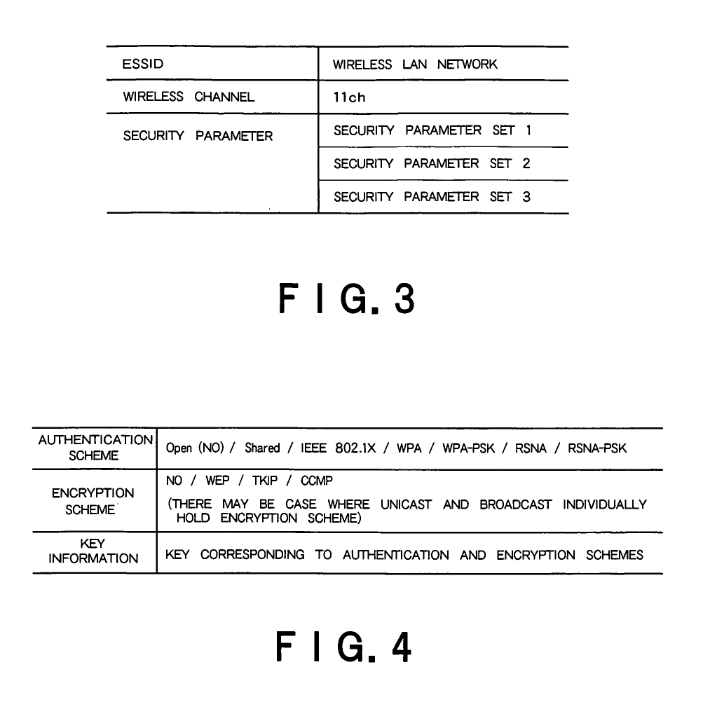

FIG. 3 shows an example of parameter information held by the APMAC control unit 16. The parameter information shown in FIG. 3 includes an ESSID, a wireless channel and a security parameter. The ESSID is an identifier of a network hosted by the access point 2, which is defined by specifications of IEEE802.11. The wireless channel is a numeric value indicating the frequency band of the radio wave used by the access point 2, and the numeric value is defined by the specifications of IEEE802.11 series. The security parameter is a parameter for setting an authentication scheme, an encryption scheme and so on. When the AP MAC control unit 16 maintains the wireless LAN segment, other security parameters defined by the IEEE802.11 series besides those shown in FIG. 3 may be required to be maintained and controlled, if necessary.

Typically, an administrator sets only one type of security parameter and processing is performed using an authentication scheme and an encryption scheme based on the set security parameter. In contrast, the present embodiment is characterized, as shown in FIG. 3, by holding a security parameter including a plurality of security parameter sets. Note that, although three parameter sets are held in FIG. 3, the number of the security parameter sets should be determined under the control policy of the administrator of the access point 2 and within the allowable range of the implementation, and there is no particular limit on it.

FIG. 4 shows the types of parameters included in a security parameter set and possible values taken by each parameter. As shown in FIG. 4, the security parameter set includes an authentication scheme, an encryption scheme and key information.

The authentication scheme in FIG. 4 specifies an authentication scheme for verifying whether a wireless terminal 1 connecting to the access point 2 is legitimate or not. The seven types of authentication schemes are listed in FIG. 4 for example only assuming the IEEE802.11 series and WPA developed by Wi-Fi, and the method is not limited to any particular type of authentication scheme in the present embodiment.

The encryption scheme specifies the cryptography of data communicated by the access point 2 and the wireless terminal 1 to each other. The four types of encryption schemes in FIG. 4, as with the authentication scheme, are listed for example only assuming the IEEE802.11 series and WPA developed by Wi-Fi, and the scheme is not limited to any particular type of encryption scheme in the present embodiment.

The key information corresponds to a specified authentication scheme or an encryption scheme and may include a character string or data sequence in many cases. A length of the character string or data sequence is a length depending on the authentication scheme and the encryption scheme.

It is noted that other parameters than those shown in FIG. 4 may be included in the security parameter set. In that case, the types or values of the parameters may be maintained and managed as needed.

Conventionally, a connection has not been able to be established only between an access point 2 and a wireless terminal 1 that share a specific security parameter. Therefore, the administrator of the access point 2 and the user of the wireless terminal 1 must have agreed with which security parameter to use in advance.

On the contrary, the access point 2 of the present embodiment can hold a plurality of security parameters, and so the administrator of the access point 2 can set a plurality of allowable security parameters and can increase the number of connectable wireless terminals 1. Also, because the information that needs to be agreed upon between the access point 2 and the wireless terminal 1 in advance can be reduced, the time to be taken until the authentication is completed can be reduced.

The present embodiment provides a security parameter set without security (or its equivalent) as one of the security parameter sets. This allows for performing connection without security to performing authentication procedure, exchanging the security parameters and performing a full connection with security. Therefore, as described above, it is unnecessary to provide the access point with security separate from the access point without security. As a result, with only one access point 2, it is possible to switch the settings with or without security.

The following description will present a detailed procedure by which an access point 2 holding a plurality of security parameter sets establishes a connection with a wireless terminal 1.

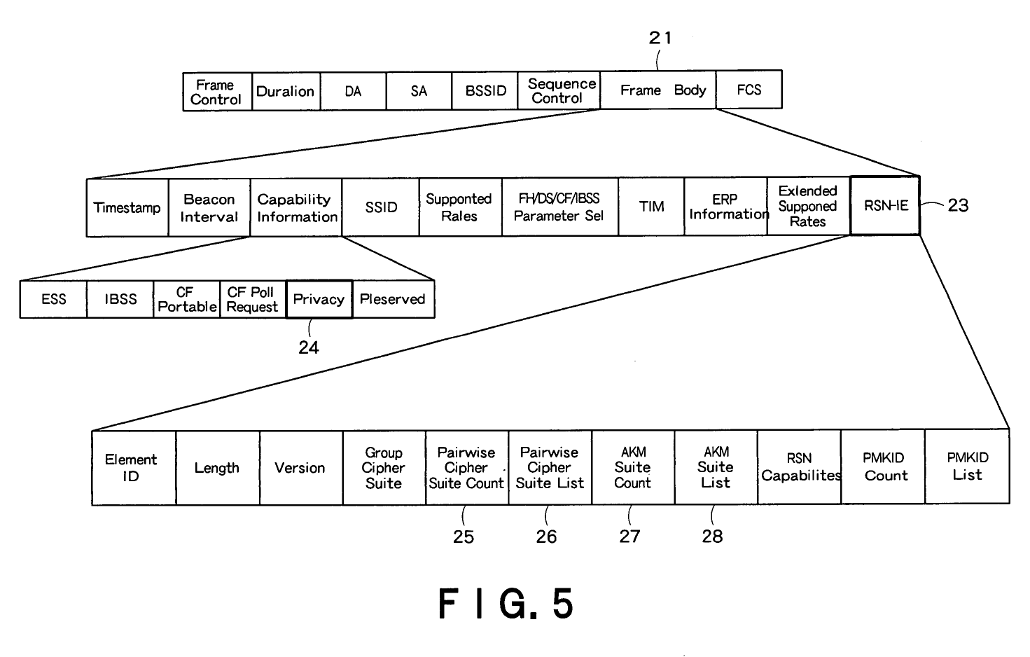

According to the specifications of the IEEE802.11 series cited as an example in the present embodiment, the access point 2 must set an assigned security parameter within a beacon frame. FIG. 5 illustrates configuration of a beacon frame in the IEEE802.11 series standards. As shown in FIG. 5, the beacon frame has a hierarchical structure. When a plurality of security parameter sets are provided, Capability information 22 and RSN-IE 23 within a frame body 21 (Frame Body) are affected. More specifically, a Privacy field 24 within the Capability information 22 contains information indicating whether encryption is used or not. Additionally, a Pairwise Cipher Suite Count field 25 within the RSN-IE 23 contains the number of encryption schemes, and a Pairwise Cipher Suite List field 26 contains the identifiers and values of the encryption schemes. Further, an AKM Suite Count field 27 within the RSN-IE 23 contains the number of authentication schemes, and an AKM Suite List field 28 contains the identifiers and values of the authentication schemes. Note that detailed information of the RSN-IE 23 is given in the specifications of the IEEE802.11i standards and is not discussed here further in detail.

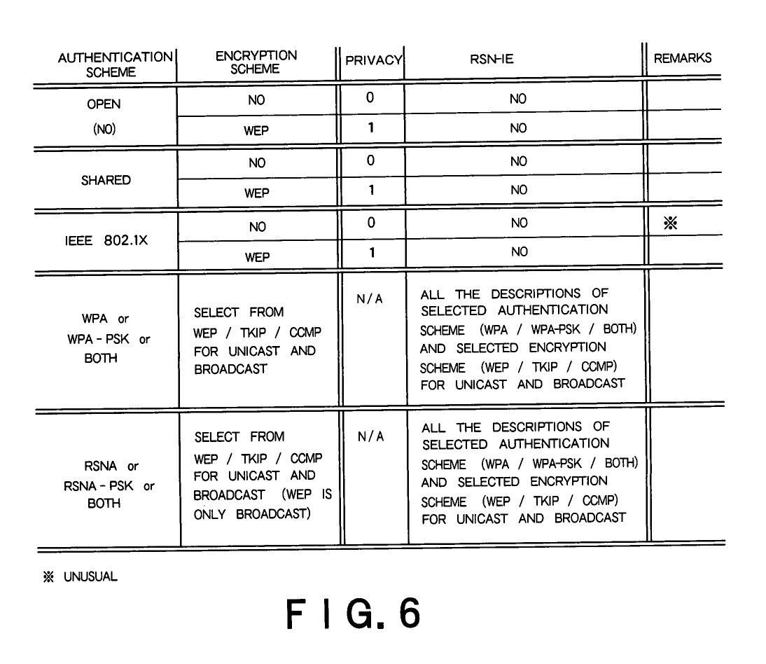

FIG. 6 provides a correspondence among the authentication scheme, the encryption scheme, the Privacy field 24 and the RSN-IE 23.

The Privacy field 24 is used only when the authentication scheme is Open, Shared or IEEE802.1x. When the Privacy field 24 is used, it contains “1” if an encryption scheme is used, and it contains “0” if it is not used. On the other hand, if the authentication scheme is WPA, WPA-PSK, RSNA or RSNA-PSK, the Privacy field 24 is not used.

The RSN-IE 23 is a field used when the authentication scheme is WPA, WPA-PSK, RSNA or RSNA-PSK. It is possible to describe a plurality of combinations in the RSN-IE 23 except for the combination of no authentication and no encryption.

The present embodiment provides first connection processing and second connection processing as the types of connection processing between the access point 2 and the wireless terminals 1. These will now be described in sequence below.

(First Connection Processing)

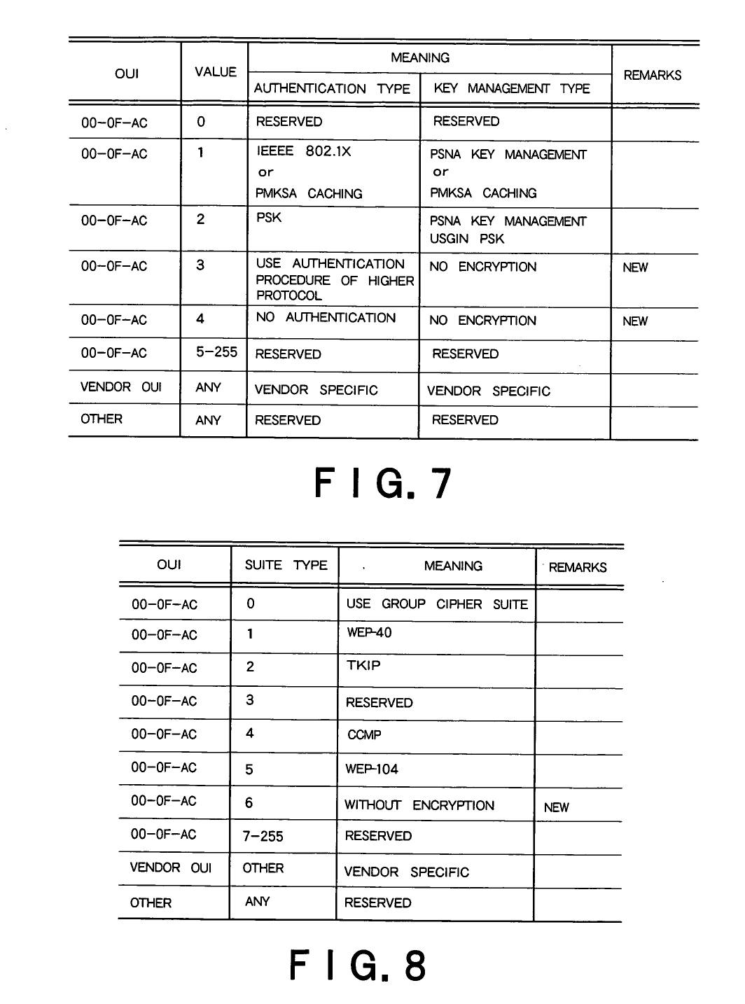

FIG. 7 shows an example of the description of the AKM Suite List field 28 within the RSN-IE 23 in the first connection processing. The fourth and fifth information from the top of FIG. 7 has been newly added. The fourth information indicates that a connection is established using the authentication procedure of a higher protocol than the IEEE802.11 series and without encryption. The fifth information indicates that a connection is established without authentication and encryption.

The values of OUI (Organizationary Unique Identifier) and Value included in the fourth and fifth information respectively are only one example, and other values may also be assigned.

FIG. 8 shows an example of the description of the Pairwise Cipher Suite List field 26 within the RSN-IE 23 in the first connection processing. The seventh information from the top of FIG. 8 has been newly added. This information indicates “No Encryption.” The values of OUI and Value in this information are only one example and other values may also be assigned.

Of the wireless terminals 1 which received the beacon including the RSN-IE 23 in FIG. 7 and FIG. 8, the wireless terminals 1 which are able to interpret the RSN-IE 23 can establish a connection to the access point 2 which sent the beacon with no authentication and no encryption, and can (or must) implement the authentication procedure of a higher protocol.

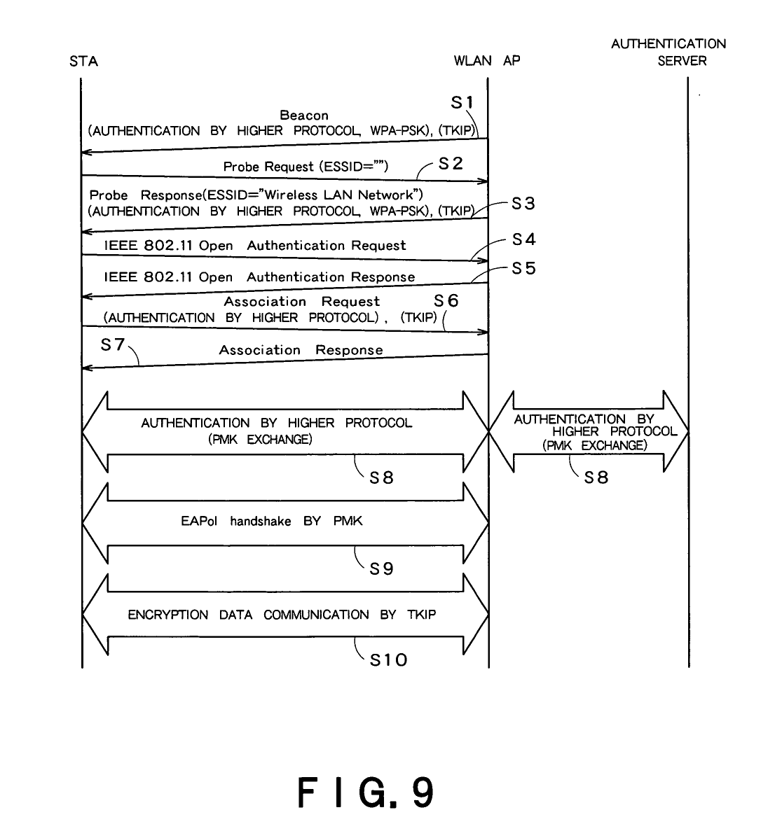

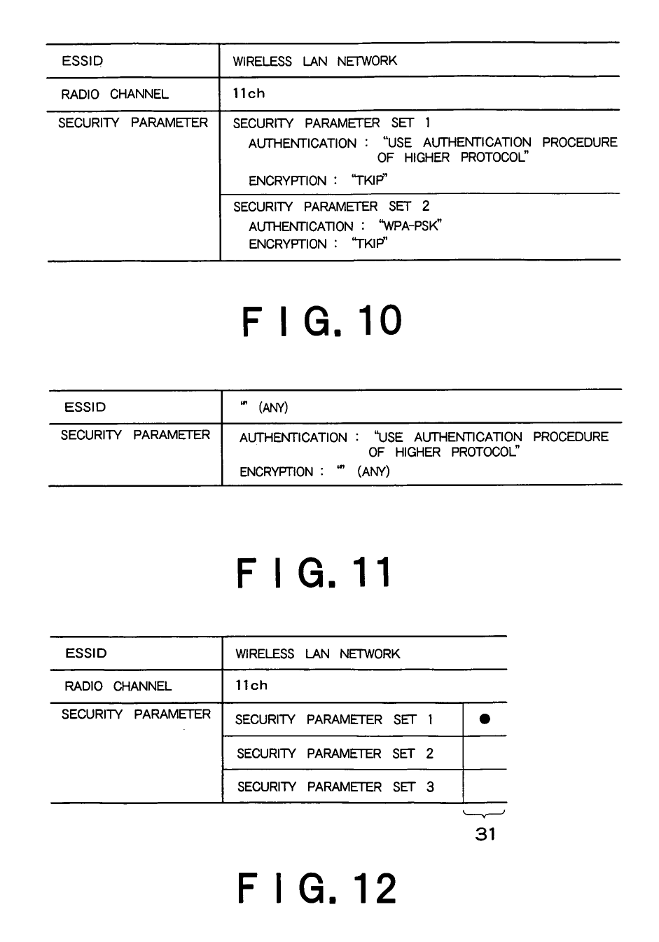

FIG. 9 is a sequence diagram illustrating the detailed processing procedure of the first connection processing. When performing the processing shown in FIG. 9, it is assumed that the AP MAC control unit 16 within the access point 2 holds a control table of a security parameter as shown in FIG. 10 and the wireless terminal 1 holds a security parameter as shown in FIG. 11.

As shown in FIG. 10, the access point 2 is assumed to hold a security parameter consisting of two types of security parameter sets 1, 2. The security parameter set 1 is defined to use an authentication procedure of a higher protocol and an encryption scheme “TKIP.” The security parameter set 2 is defined to use an authentication scheme “WPA-PSK” and an encryption scheme “TKIP.” On the other hand, the wireless terminal 1, as shown in FIG. 11, is defined to use an authentication procedure of a higher protocol, but to use no particular encryption.

The processing procedure of the first connection processing is now described below based on FIG. 9. First, the access point 2 transmits a beacon (step SI). The RSN-IE 23 within this beacon frame includes descriptions indicating that authentication procedure of the higher protocol are used and then the authentication scheme “WPA-PSKI” and the encryption scheme “TKIP” are used.

The wireless terminal 1 that received this beacon issues a Probe Request to the access point 2 (step S2). The access point 2 that received this Probe Request returns a Probe Response to the wireless terminal 1 (step 53). This Probe Response includes descriptions indicating that the ESSID is “Wireless LAN Network,” that an authentication scheme “WPA-PSKI” is used after establishing a connection using an authentication procedure of a higher protocol, and that an encryption scheme “TKIP” is used.

The wireless terminal 1 that received the Probe Response issues an Authentication Request to the access point 2 (step S4). The access point 2 that received this Authentication Request sends an Authentication Response according to the IEEE802.11 standards to the wireless terminal 1 (step S5).

The wireless terminal 1 that received the Authentication Response issues an Association Request using the authentication procedure of the higher protocol and the encryption scheme “TKIP” to the access point 2 (step 56). The access point 2 that received this Association Request returns an Association Response to the wireless terminal 1 (step S7).

Then, the wireless terminal 1, the access point 2 and the authentication server 3 implement the authentication processing with the higher protocol (step S8). The authentication processing implemented here is an authentication processing for using a data link layer subsequently. If successful in the authentication, the access point 2 and the wireless terminal 1 exchange PMKs (Pair-wise Master Keys) with each other.

Then, handshake using the PMKs (EAPOL handshake) is performed (step S9). Subsequently, the access point 2 and the wireless terminal 1 initiate encrypted data communications using the authentication scheme “WPA-PSK” and the encryption scheme “TKIP” (step S10).

(Second Connection Processing)

In the case of the first connection processing, wireless terminals 1 using WEP and IEEE802.1x which does not interpret the RSN-IE 23, or the terminals which cannot interpret parameters newly added to the RSN-IE 23, even if they receive a beacon from the access point 2, they cannot perform connection processing without authentication and encryption, thus cannot perform connection processing using an authentication procedure of a higher protocol either. Therefore, in the second connection processing, the access point 2 automatically switches security parameter sets. The detailed description of the second connection processing is presented below.

FIG. 12 shows a control table of a security parameter held by the AP MAC control unit 16 within the access point 2. As shown in FIG. 12, the access point 2 has flag information 31 indicating that security parameter is currently in use. The example in FIG. 12 shows that security parameter set 1 is currently in use. The access point 2 determines the next security parameter set to be selected based on this flag information 31. This enables the setting of the security parameter set to be automated.

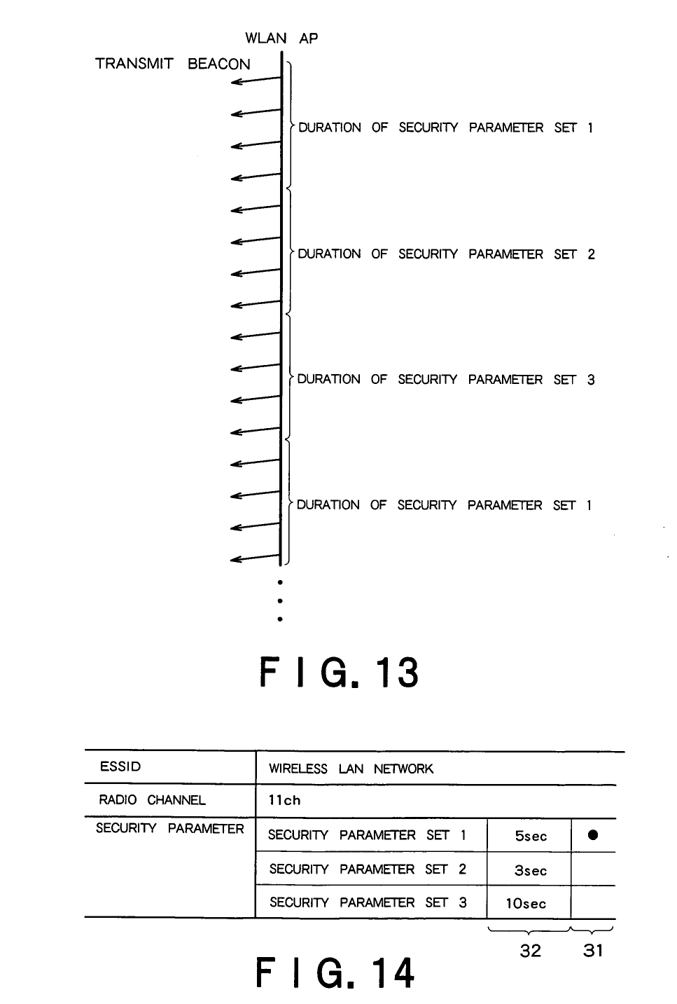

FIG. 13 illustrates timings at which the access point 2 switches security parameter sets. Each arrow in FIG. 13 indicates a timing at which the access point 2 sends a beacon. In the case of FIG. 13, the access point 2 switches security parameter sets at regular time intervals. For example, a beacon may be sent every 250 ms, and the security parameter sets may be switched every second.

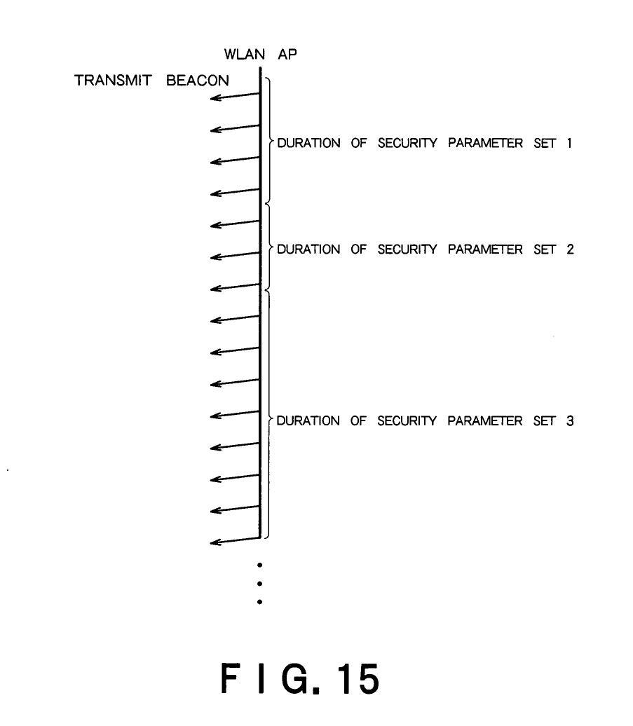

Alternatively, a particular duration may be set for each security parameter set, instead of switching security parameter sets at regular time intervals as shown in FIG. 13. FIG. 14 shows an example of the control table of the security parameter held by the AP MAC control unit 16 within the access point 2, into which information 32 about the duration of each security parameter set has been added, FIG. 15 illustrates the switching timings of the security parameter sets corresponding to FIG. 14. The access point 2 switches the security parameter sets in sequence according to the duration 32 described in the control table of FIG. 14. Therefore, as shown in FIG. 15, the duration changes in different ways depending on the assigned security parameter set.

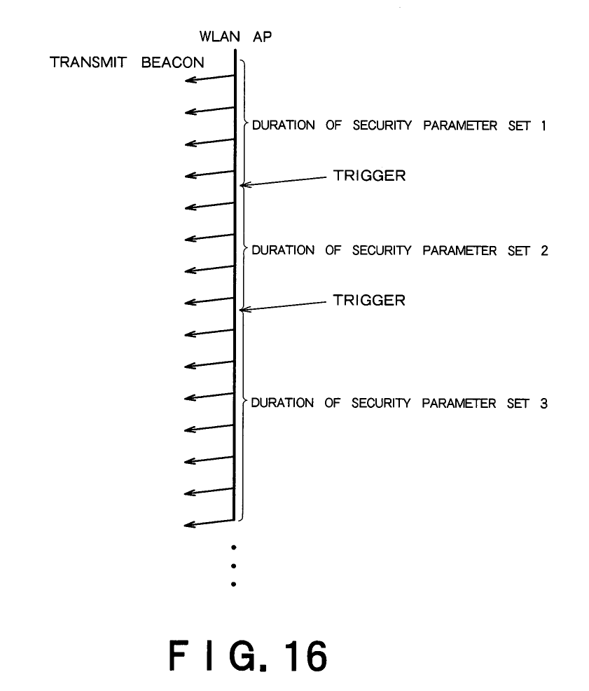

In FIG. 13 and FIG. 15, although the access point 2 switches the security parameter sets at its own discretion, the security parameter sets may also be switched in sync with a trigger signal from an external device (for example, the authentication server 3). FIG. 16 is a timing diagram illustrating an example in which security parameter sets change in sync with a trigger signal. As shown in FIG. 16, the security parameter sets changes in turn in sync with a timing when the access point 2 receives the trigger signal from an external device.

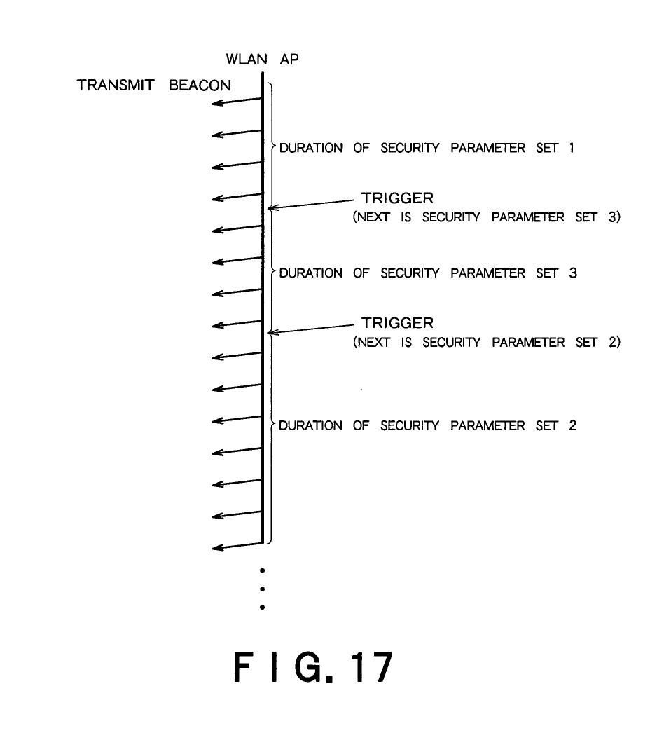

As a variation of FIG. 16, information about the type of the next security parameter set to be selected may be included in the trigger signal from the external device. In this case, the timing diagram will look like the one shown in FIG. 17. The access point 2 interprets the information about the security parameter set included in the trigger signal to set the next security parameter set.

It may be possible to arbitrarily select any of the above described techniques for switching security parameter sets. Or the switching of the security parameter sets may be changed in midstream.

Note that, although the security parameter sets may be selected in any order, the selection may be made in ascending or descending order of the unique identification values of the security parameter sets, or the selection order may be changed for each cycle, or the security parameter sets may be selected randomly or according to the order specified by an external device as described with reference to FIG. 16 and FIG. 17.

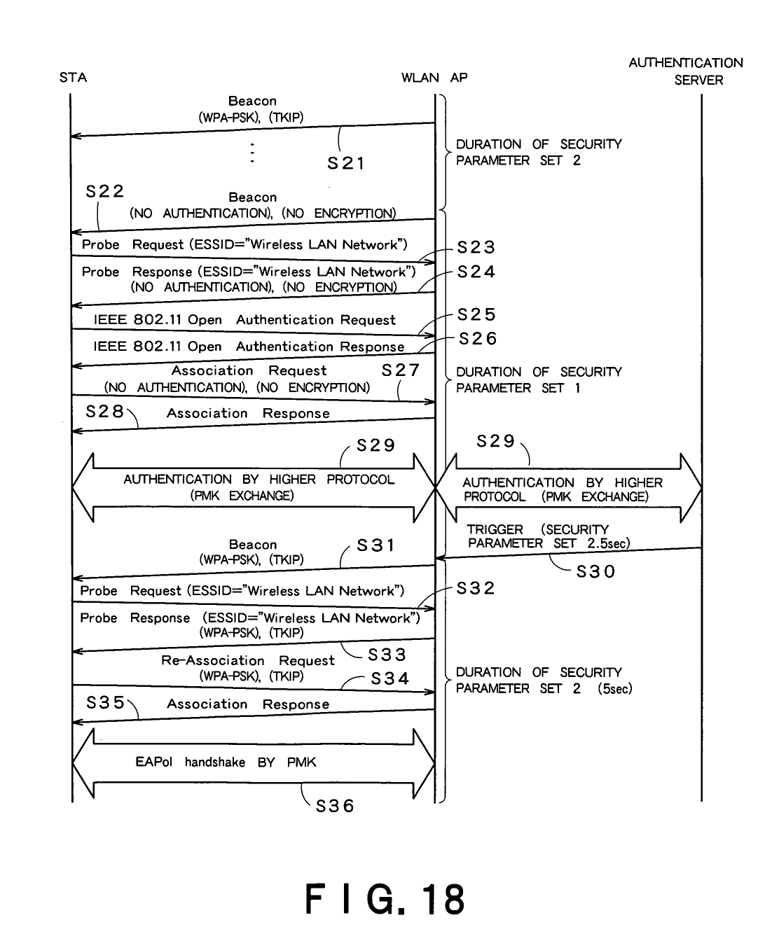

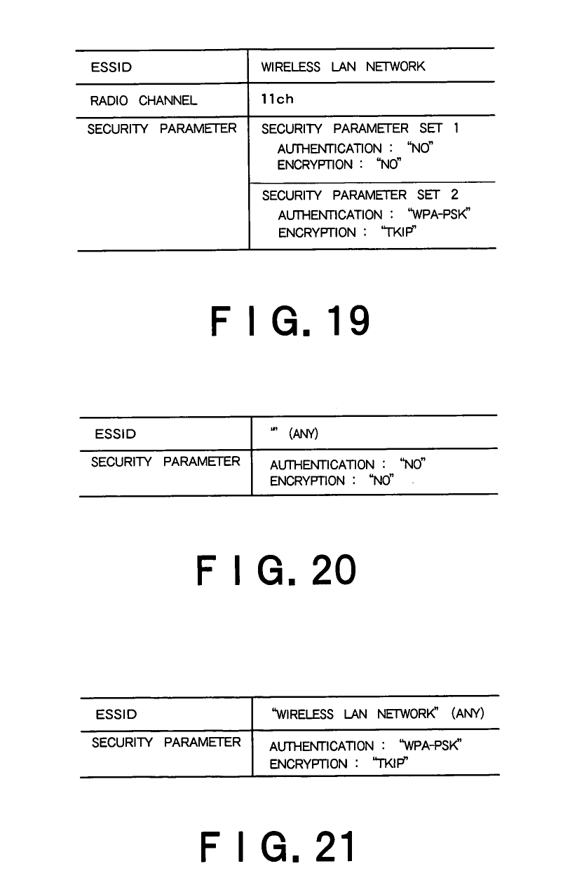

FIG. 18 is a sequence diagram illustrating the detailed processing procedure of the second connection processing. When performing the processing shown in FIG. 18, the AP MAC control unit 16 within the access point 2 is assumed to hold a control table of security parameters shown in FIG. 19. As shown in FIG. 19, the access point 2 has two types of security parameter sets 1, 2. The security parameter set 1 is defined to perform connection processing without authentication and encryption, and the security parameter set 2 is defined to perform connection processing using an authentication scheme “WPA-PSK” and an encryption scheme “TKIP.” First, step S21 shows that although the access point 2 tries connection with the authentication scheme “WPA-PSK” and the encryption scheme “TKIP”, it fails to the connection. Then, the access point 2 sends the beacon including information indicating the connection without authentication and encryption to the wireless terminal 1 (step S22). In this case, the parameter information assigned to the wireless terminal 1 will be shown in FIG. 20.

Then, in steps S23 to S29, processing steps similar to the steps S1 to S8 in FIG. 9 are performed. More specifically, the access point 2 performs the authentication procedure using a higher protocol with the authentication server 3 to perform authentication and key exchange.

The authentication server 3 sends a trigger signal so that the successful wireless terminal 1 can quickly establish a connection with security (step S30). This trigger signal includes information about the security parameter set to be selected by the access point 2 and the validity period of the security parameter set. As an example, the trigger signal may include information indicating that the security parameter set 2 is valid for 5 seconds.

The access point 2 sends the beacon signal including the authentication scheme “WPA-PSK” and the encryption scheme “TKIP” specified in the trigger signal (step S31). The wireless terminal 1 which receives this beacon will have a security parameter shown in FIG. 21.

Then, the terminal 1 and the access point 2 exchange a Probe Request and a Probe Response (step S32, S33), then exchange an Association Request and an Association Response using the authentication scheme “WPA-PSKI” and the encryption scheme “TKIP” (step S34, S35), and conduct an authentication and key exchange (step S36).

In this manner, in the present embodiment, since an access point 2 holds a plurality of security parameter sets and switches them as need arises, it can establish a connection with a wireless terminal 1 simply and quickly, and can perform highly secured and safe wireless communications. Especially, the access point 2 initially establishes the connection with the wireless terminal 1 without authentication and encryption, and then establishes the connection by using particular authentication and encryption schemes. Therefore, it is possible to perform the wireless communication with the wireless terminal quickly and securely by using a plurality of authentication and encryption schemes.

Further, according to the present embodiment, the next security parameter set to be used may also be informed to an access point 2 by an external device. Therefore, it is unnecessary to perform selection processing of the security parameter sets by the access point 2 itself, thereby simplifying the processing operations of the access point 2.

What is claimed is:

1. A base station comprising:
a wireless unit configured to perform wireless communication with a wireless terminal by using a predetermined protocol, authentication schemes, and encryption schemes; and
a control unit configured to select one of a plurality of security parameter sets relating to the authentication schemes and the encryption schemes at a predetermined timing to provide the selected security parameter set to the wireless terminal via the wireless unit.

2. The base station according to claim 1,
wherein the control unit holds the plurality of security parameter sets used for the wireless communication in a data link layer.

3. The base station according to claim 1,
wherein the control unit holds the security parameter set with no authentication and no encryption and the security parameter with a particular authentication and encryption schemes, which are included in the plurality of security parameter sets,
just after beginning wireless communication with the wireless terminal, the control unit performing a first authentication procedure using a higher protocol than the predetermined protocol by using the security parameter set with no authentication and no encryption,
when the first authentication procedure is successful, the control unit performing a second authentication procedure in a data link layer by using the security parameter set relating to the particular authentication and encryption schemes,
when the second authentication procedure is successful, the control unit performing wireless communication encrypted by the particular encryption scheme.

4. The base station according to claim 1,
wherein the control unit holds the security parameter set with no authentication and no encryption, which is included in the plurality of security parameter sets,
just after beginning wireless communication with the wireless terminal, the control unit performing a first authentication procedure using a higher protocol than the predetermined protocol by using the security parameter set with no authentication and no encryption,
when the first authentication procedure is successful, the control unit performing switching to the security parameter set with a particular authentication and encryption schemes transmitted from an external device to perform a second authentication procedure in a data link layer,
when the second authentication procedure is successful, the control unit performing wireless communication encrypted by the particular encryption scheme.

5. The base station according to claim 1,
wherein the control unit selects one of the plurality of security parameter sets for every a predetermined time to provide the selected security parameter set to the wireless terminal via the wireless unit.

6. The base station according to claim 1,
wherein the control unit selects one of the plurality of security parameter sets by a period set individually for each of the plurality of security parameter sets to provide the selected security parameter set to the wireless terminal via the wireless unit.

7. The base station according to claim 1,
wherein the control unit selects one of the plurality of security parameter sets in synchronization with a trigger signal outputted by an external device to provide the selected security parameter set to the wireless terminal via the wireless unit.

8. The base station according to claim 7,
wherein the control unit selects a next security parameter set to be selected based on information relating to the next security parameter to be selected among the plurality of security parameter sets, the information being outputted with the trigger signal by the external device.

9. A wireless communication system comprising:
a wireless terminal; and
a base station configured to perform wireless communication with the wireless terminal, the base station includes:
a wireless unit configured to perform wireless communication with a wireless terminal by using a predetermined protocol, authentication schemes, and encryption schemes; and
a control unit configured to select one of a plurality of security parameter sets relating to the authentication schemes and the encryption schemes at a predetermined timing to provide the selected security parameter set to the wireless terminal via the wireless unit.

10. The wireless communication system according to claim 9,
wherein the control unit holds the plurality of security parameter sets used for the wireless communication in a data link layer.

11. The wireless communication system according to claim 9,
wherein the control unit holds the security parameter set with no authentication and no encryption and the security parameter with a particular authentication and encryption schemes, which are included in the plurality of security parameter sets,
just after beginning wireless communication with the wireless terminal, the control unit performing a first authentication procedure using a higher protocol than the predetermined protocol by using the security parameter set with no authentication and no encryption,
when the first authentication procedure is successful, the control unit performing a second authentication procedure in a data link layer by using the security parameter set relating to the particular authentication and encryption schemes,
when the second authentication procedure is successful, the control unit performing wireless communication encrypted by the particular encryption scheme.

12. The wireless communication system according to claim 9,
wherein the control unit holds the security parameter set with no authentication and no encryption, which is included in the plurality of security parameter sets,
just after beginning wireless communication with the wireless terminal, the control unit performing a first authentication procedure using a higher protocol than the predetermined protocol by using the security parameter set with no authentication and no encryption,
when the first authentication procedure is successful, the control unit performing switching to the security parameter set with a particular authentication and encryption schemes transmitted from an external device to perform a second authentication procedure in a data link layer,
when the second authentication procedure is successful, the control unit performing wireless communication encrypted by the particular encryption scheme.

13. A base station control program comprising:
selecting one of a plurality of security parameter sets relating to authentication schemes and encryption schemes used for wireless communication with a wireless terminal at a predetermined timing; and
transmitting information relating to the authentication scheme and encryption scheme of the selected security parameter set to the wireless terminal.

14. The base station control program according to claim 13,
wherein the plurality of security parameter sets are used for the wireless communication in a data link layer.

15. The base station control program according to claim 13,
wherein just after beginning wireless communication with the wireless terminal, a first authentication procedure using a higher protocol than a predetermined protocol is performed by using the security parameter set with no authentication and no encryption,
when the first authentication procedure is successful, a second authentication procedure in a data link layer is performed by using the security parameter set relating to the particular authentication and encryption schemes,
when the second authentication procedure is successful, wireless communication encrypted by the particular encryption scheme is performed.

16. The base station control program according to claim 13,
wherein just after beginning wireless communication with the wireless terminal, a first authentication procedure using a higher protocol than a predetermined protocol is performed by using the security parameter set with no authentication and no encryption,
when the first authentication procedure is successful, switching to the security parameter set with a particular authentication and encryption schemes transmitted from an external device is performed for a second authentication procedure in a data link layer,
when the second authentication procedure is successful, wireless communication encrypted by the particular encryption scheme is performed.

17. A base station control method comprising:
selecting one of a plurality of security parameter sets relating to authentication schemes and encryption schemes used for wireless communication with a wireless terminal at a predetermined timing; and
transmitting information relating to the authentication scheme and encryption scheme of the selected security parameter set to the wireless terminal.

18. The base station control method according to claim 17,
wherein the plurality of security parameter sets are used for the wireless communication in a data link layer.

19. The base station control method according to claim 17,
wherein just after beginning wireless communication with the wireless terminal, a first authentication procedure using a higher protocol than a predetermined protocol is performed by using the security parameter set with no authentication and no encryption,
when the first authentication procedure is successful, a second authentication procedure in a data link layer is performed by using the security parameter set relating to the particular authentication and encryption schemes,
when the second authentication procedure is successful, wireless communication encrypted by the particular encryption scheme is performed.

20. The base station control method according to claim 17,
wherein just after beginning wireless communication with the wireless terminal, a first authentication procedure using a higher protocol than a predetermined protocol is performed by using the security parameter set with no authentication and no encryption,
when the first authentication procedure is successful, switching to the security parameter set with a particular authentication and encryption schemes transmitted from an external device is performed for a second authentication procedure in a data link layer,
when the second authentication procedure is successful, wireless communication encrypted by the particular encryption scheme is performed.
